(19) United States
(12) Patent Application Publication
(10) Pub. No.: US 2004/0108821 A1
(43) Pub. Date: Jun. 10, 2004

(54) Compound color optical LED

(76) Inventor: Tai-Ning Tang, Taipei (TW)

Correspondence Address: RABIN & BERDO, P.C., Suite 500, 1101 14th Street, N.W., Washington, DC, 20005, US

(21) Appl. No.: 10/314,955

(22) Filed: Dec. 10, 2002

(51) Int. Cl. H01J 7/44

(52) U.S. Cl. 315/291; 315/56; 315/362; 362/800

(57) ABSTRACT

A compound color LED comprises a light-and-off controller IC, a plurality of different colored mini-LEDs, and a variable resistor; each of the components is installed into a transparent light body of a LED of regular size, and the light-and-off controller IC is driven by using a direct current of low voltage between 3˜4.5V, and the output of the light-and-off controller IC controls each mini-LED to produce the on and off lighting effect, so that the lamp of the present invention emits colorful light with glistering variation to attain the effect of producing a variety of colored light by means of a single common LED lamp.

### BACKGROUND OF THE INVENTION

1. Field of the Invention

The present invention relates to a compound color optical LED, more particularly to a LED comprising a compact light-and-off controller IC, a plurality of different colored mini-LED, and a variable transistor; each component is installed inside a transparent LED lamp of regular size to provide a multi-color light emitting component, wherein a low voltage in the range of 3˜4.5V of a direct current is used to drive the light-and-off controller IC, and the output of the light-and-off controller IC controls each of the mini-LED of the present invention to produce an on and off glistering variation. A single lamp of regular size according to the present invention is capable of producing a colorful light variation, and attaining the color variation effect of which the prior art requires several LED lamps of different color. The advantage of the LED according to the present invention includes its compactness, flexibility, and capability of being used in many different occasions that require different sizes and limitations. The scope of the application of the present invention is broad, and definitely improves the performance of the prior art.

2. Description of the Related Art

Since the volume of LED lamp is quite small, and easy to install, therefore it is widely used in many machines and tools, electric appliances or toys, ornaments; particularly to the toy or ornament, it creates a beautiful looking and interesting variation effect. As lamp has higher requirements on colors, and thus different colored LEDs are used for assembling traditional lamps. The conventional LED lamp is a lamp with only one color generally in white, red, yellow, green, blue, and orange color. It needs to install at least several different colored optical LED and lets these individual LEDs show the light-and-off effect at individual position in order to have different lighting effects. However, the installation of several LEDs of this sort requires holes or socket to accommodate these LEDs and these LEDs have to be installed one by one, which makes the installation more complicated and even may damage the artistic style of the object itself. The assembling process becomes more complicated, which results a higher cost. Furthermore, if we want to install several LED of different colors, it is difficult to put these LEDs into the limited space because the object itself is compact in size. It is not difficult to imagine that the assembling will be very difficult and inconvenient.

Therefore, in view of the problems caused by the traditional LED having only a single color light and definitely having many shortcomings when it is actually used, the inventor of the present invention based on years of experience accumulated from the engagement in the related industry conducted extensive research to resolve the aforementioned problem. After the research process of formulating ideas, trial, testing, and modification, the present inventor finally produced and trial run a high performance finished goods and successfully invented a “Compound Colored Optical LED” which is a lamp of regular size capable of producing several beautiful colors with the light-and-off glistering variation effect. It greatly simplifies the structure and assembling procedure of an object with multiple-color application as well as the LED installation. The present invention also can reduce cost and simplify manufacturing procedure, and effectively enhance the scope of application and flexibility for variations.

The primary objective of the present invention is to provide a compound color LED comprising a light-and-off controller IC, a plurality of different colored mini-LEDs, and a variable resistor; each of the components is installed into a transparent light body of a LED of regular size, and the light-and-off controller IC is driven by using a direct current of low voltage between 3˜4.5V, and the output of the light-and-off controller IC controls each mini-LED to produce the on and off lighting effect, so that the lamp of the present invention emits colorful light with glistering variation to attain the effect of producing a variety of colored light by means of a single common LED lamp.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

Other objects, features, and advantages of the invention will become apparent from the following detailed description of the preferred but non-limiting embodiment. The description is made with reference to the accompanying drawings, in which:

FIG. 1 is a schematic circuit diagram of the present invention.

FIG. 2 is a schematic diagram of the structure of the present invention.

FIG. 3 is a schematic diagram of the overall appearance of the present invention.

### DETAILED DESCRIPTION OF THE PREFERRED EMBODIMENTS

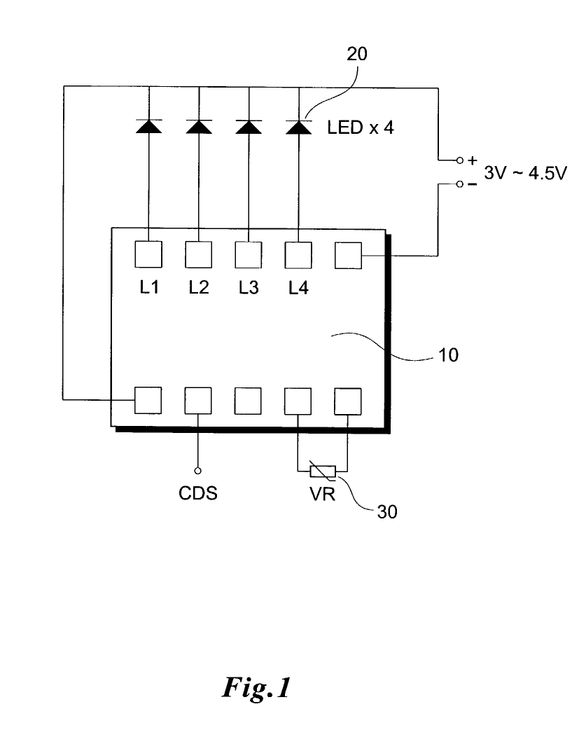

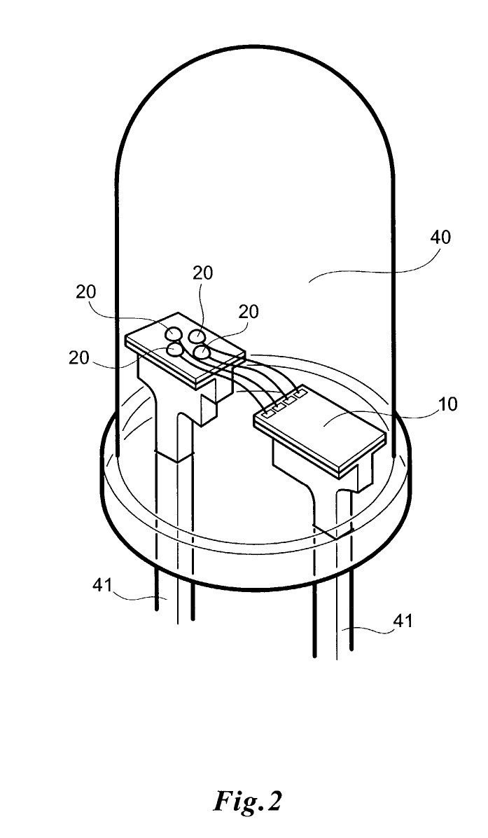

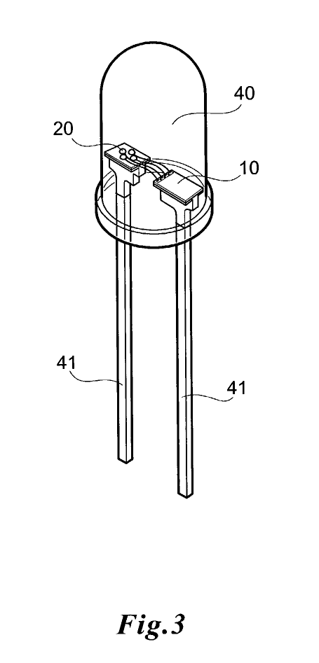

Please refer to FIGS. 1 to 3. The present invention comprises a compact light-and-off controller IC 10, a plurality of mini-LEDs 20 of different color, and a variable resistor 30; each component is installed in a transparent LED lamp body 40; two pins 41 are separately coupled to the appropriate position on the light-and-off controller IC 10 and each of the mini-LED 20 for the electric wire connection; such structure can use the direct current with low voltage in the range of 3˜4.5V to drive the light-and-off controller IC 10. The output of the light-and-off controller IC 10 controls each mini-LED 20 so that each mini-LED 20 produces the on-and-off glittering variation effect. Since every mini-LED 20 is of different color, and all of them are installed in the same LED lamp body 40, therefore when the LED lamp according to the present invention is connected and operated, we can observe the on and off glittering variation of colorful lights with dynamic effect through the transparent LED lamp body 40. Not only showing different colors (such as red, yellow, blue, and green, etc.) alternately, the present invention also makes use of the light-and-off controller IC 10 to control and set each mini-LED 20 so that the on and off of every mini-LED 20 produces a delayed superimposition situation, and the LED lamp 40 of the same volume generates an effect of mixed color (such as mixing a red light with a blue light to show a purple light). The present invention provides an artistic look with variations.

Further, as to the object requiring several color lights, the present invention only use a LED lamp 40 of the same size of a traditional one to fully meet the requirements. Therefore, such object just needs to prepare a hole or socket on the object to receive the LED and may save a manufacturing step when assembling the LED of the present invention with the object. Compared with the prior art that requires additional structure and manufacturing to accomplish the same effect, the present invention can effectively and greatly simplify the structure and manufacturing procedure, which is cost-efficient. Of course, there is no problem at all if users want to install more LEDs of the present invention on the object simultaneously. The multiple of installed LED according to the present invention can show a variety of colorful displaying effects, and definitely cannot be accomplished by the same number of prior-art LED lamps. Since the present invention only uses a LED lamp body 40 to attain the colorful glittering variation effect, therefore it is particularly applicable to install the LED of the present invention onto all kinds of mini and compact electric appliance or toy, ornament; the scope of application is much broader and more flexible than the prior-art LED.

In summation of the above description, the present invention makes use of a novel structure with excellent design to create control mechanism for a multiple color and light-and-off variation. By setting all LEDs into a single LED lamp body and let such LED lamp body to produce colorful display during its operation, and also attain the effects of on-and-off dynamic variation and mixed colors. The present invention not only has advantage on its structure, but also only can simplify the manufacturing process in order to reduce cost, simplify structure and manufacturing procedure, as well as enhance the performance. Compared with the prior art, the present invention definitely has improvement over the traditional LED, and further complies with the patent application requirements and is submitted to the Patent and Trademark Office for review and granting of the commensurate patent rights.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A compound color optical LED, comprising: a compact light-and-off controller IC; a plurality of different colored mini-LED; and a variable transistor; each component being installed inside a transparent LED lamp body of regular size; two pins extended individually from the an appropriate position on the light-and-off controller IC and the mini-LED is coupled to the pin of the power supply; a low voltage in the range of 3 to 4.5V being used to drive the light-and-off controller IC, such that the output of the light-and-off controller IC controls each of the mini-LED to produce the alternate on-and-off variation effect through the LED lamp body, and further shows a colorful glistering light effect.
